(19) United States
(12) Patent Application Publication
(10) Pub. No.: US 2025/0168573 A1
(43) Pub. Date: May 22, 2025

(54) HEARING DEVICE WITH RECEIVER SHOCK PROTECTION

(71) Applicant: GN Hearing A/S, Ballerup (DK)

(72) Inventors: Yu LUAN, Kongens Lyngby (DK); Emil Holm KNUDSEN, Copenhagen (DK)

(73) Assignee: GN Hearing A/S, Ballerup (DK)

(21) Appl. No.: 18/932,605

(22) Filed: Oct. 30, 2024

(30) Foreign Application Priority Data
Nov. 16, 2023 (EP) 23210248.3

(51) Int. Cl. H04R 25/00

(52) U.S. Cl. CPC H04R 25/456; H04R 25/60; H04R 25/65

(57) ABSTRACT

A hearing device is disclosed. The hearing device comprises a housing comprising a frame and a shell. The hearing device comprises a receiver arranged within the housing. The housing and the receiver form at least a part of a first mass spring system having a first resonance frequency. The housing and the receiver form at least a part of a second mass spring system having a second resonance frequency larger than 10 KHz.

### RELATED APPLICATION DATA

This application claims priority to, and the benefit of European Patent Application No. 23210248.3 filed on Nov. 16, 2023. The entire disclosure of the above application is expressly incorporated by reference herein.

### FIELD

The present disclosure relates to shock protection of hearing devices and in particular to a hearing device comprising a housing with frame and a shell, and a receiver arranged within the housing.

### BACKGROUND

It is a challenge to protect the components of a hearing device, such as a Behind the Ear (BTE) hearing devices from impact damage. For example, a user of a hearing device may drop the hearing device when taking it off or putting it on. Alternatively, the hearing device may fall off the ear or even be impacted while a user is wearing it. These occurrences may expose the hearing device to force peaks which may be potentially damaging to the external and/or internal components of the hearing aid.

Many hearing devices comprise a receiver as an internal component that may be damaged when the hearing device impacts and/or is impacted by an object and/or a surface.

The condition of the receiver is critical for the audio output quality of the hearing device, and therefore shock protection of the receiver is needed.

### SUMMARY

Accordingly, there is a need for hearing devices and methods with improved shock protection of the hearing device and components thereof.

A hearing device is disclosed. The hearing device comprises a housing comprising a frame and a shell, the hearing device comprising a receiver arranged within the housing. The housing and the receiver optionally form at least a part of a first mass spring system having a first resonance frequency. The housing and the receiver optionally form at least a part of a second mass spring system having a second resonance frequency, e.g. larger than 10 KHz.

It is an advantage of the present disclosure that the hearing device provides reduced risk of receiver damage caused by an impact, and e.g. enabling alternative ways to mount the receiver while also being shock protected. In other words, the present disclosure provides a reliable and robust hearing device configured for shock protection, e.g., to withstand impacts.

In other words, the disclosed hearing device comprises one or more components, such as frame, shell, damping elements and/or foam pads, which are configured for example by geometry and/or material to enable the impact period to be increased, thereby enabling the receiver to be shock protected from forces incurred by an impact, such as an impact with a surface, e.g., when the hearing device is dropped.

Further, the present disclosure enables the receiver of the hearing device to be protected from impact induced damage while maintaining acceptable levels of resonance in the hearing device. In other words, the disclosed hearing device enables improved shock protection of the receiver without sacrificing the quality of the audio signal provided by the audio device.

Furthermore, the disclosed hearing device may enable shock protection without requiring the size of the hearing device to increase.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 shows an exemplary hearing device according to the disclosure,

FIGS. 2A-B show one or more damping elements of an exemplary hearing device according to the disclosure,

FIGS. 3A-B show one or more foam pads of an exemplary hearing,

FIG. 4 shows an exemplary hearing device in a first user,

FIG. 5A shows an exemplary first mass spring system and a section of a corresponding hearing device,

FIG. 5B shows an exemplary second mass spring system, and

FIGS. 6A-B show graphs indicating measured velocities and related acceleration from drop tests on six hearing devices, and

FIG. 7 shows a hearing device with a receiver in an ITE housing.

### DETAILED DESCRIPTION

Various exemplary embodiments and details are described hereinafter, with reference to the figures when relevant. It should be noted that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

A hearing device is disclosed. The hearing device may be configured to be worn at an ear of a user and may be a hearable or a hearing aid, wherein the processor may be configured to compensate for a hearing loss of a user. The hearing device may for example be a hearing device comprising a hard mounted receiver. The hard-mounted receiver can for example be seen as a receiver which is fixed to the frame of the hearing device. For example, the hard-mounted receiver may be configured such that it is not easily removable and/or detachable from the frame of the hearing device. A hard-mounted receiver may be seen as a receiver having no or minimum mechanical decoupling in the attachment or mounting of the receiver to the frame.

In other words, the hard-mounted receiver can be seen as securely attached to the frame of the hearing device. This hard-mounted receiver may be mounted to the frame using secure mechanical means, such as via any or combinations of click-connections, press-fit, 2k moulding, and adhesives.

In some examples, the hearing device may be an earbud, a headphone, or a hearing aid, etc.

The hearing device may be a hearing aid of the behind-the-ear (BTE) type, in-the-ear (ITE) type, in-the-canal (ITC) type, receiver-in-canal (RIC) type, receiver-in-the-ear (RITE) type or microphone-and-receiver-in-the-ear (MaRIE) type. The hearing device may be a binaural hearing aid in a binaural hearing system. The binaural hearing system may comprise a first hearing aid and a second hearing aid, wherein the first hearing aid and/or the second hearing aid may be the hearing device(s) as disclosed herein.

The hearing device may be configured for wireless communication with one or more devices, such as with another hearing device, e.g., as part of a binaural hearing system, and/or with one or more accessory devices, such as a smartphone and/or a smart watch. The hearing device optionally comprises an antenna for converting one or more wireless input signals, e.g., a first wireless input signal and/or a second wireless input signal, to antenna output signal(s). The wireless input signal(s) may origin from external source(s), such as spouse microphone device(s), wireless TV audio transmitter, and/or a distributed microphone array associated with a wireless transmitter. The wireless input signal(s) may origin from another hearing device, e.g., as part of a binaural hearing system, and/or from one or more accessory devices.

The hearing device optionally comprises a radio transceiver coupled to the antenna for converting the antenna output signal to a transceiver input signal. Wireless signals from different external sources may be multiplexed in the radio transceiver to a transceiver input signal or provided as separate transceiver input signals on separate transceiver output terminals of the radio transceiver. The hearing device may comprise a plurality of antennas and/or an antenna may be configured to be operate in one or a plurality of antenna modes. The transceiver input signal optionally comprises a first transceiver input signal representative of the first wireless signal from a first external source.

The hearing device comprises a set of microphones. The set of microphones may comprise one or more microphones. The set of microphones comprises a first microphone for provision of a first microphone input signal and/or a second microphone for provision of a second microphone input signal. The set of microphones may comprise N microphones for provision of N microphone signals, wherein N is an integer in the range from 1 to 10. In one or more exemplary hearing devices, the number N of microphones is two, three, four, five or more. The set of microphones may comprise a third microphone for provision of a third microphone input signal.

The hearing device comprises a processor for processing input signals, such as pre-processed transceiver input signal and/or pre-processed microphone input signal(s). The processor provides an electrical output signal based on the input signals to the processor. Input terminal(s) of the processor are optionally connected to respective output terminals of the pre-processing unit. For example, a transceiver input terminal of the processor may be connected to a transceiver output terminal of the pre-processing unit. One or more microphone input terminals of the processor may be connected to respective one or more microphone output terminals of the pre-processing unit.

It is noted that descriptions and features of hearing device functionality, such as hearing device configured to, also apply to methods and vice versa. For example, a description of a hearing device configured to determine also applies to a method, e.g. of operating a hearing device, wherein the method comprises determining and vice versa.

The hearing device comprises a housing comprising a frame and a shell. The housing may be a BTE housing or an ITE housing. The shell may be a multi-part shell. At least a part of the shell part(s) may be attached to the frame, e.g. via click-connections, press-fit, 2k moulding or glue/adhesive, or combinations thereof.

The shell of the hearing device can be seen as the outer casing of the hearing device. In other words, the shell can be at least a part of a casing, such as a protective casing, partially encapsulating and/or fully encapsulating the internal components, e.g., the receiver and/or the frame, of the hearing device.

The frame can be seen as at least a part or chassis of the hearing device configured for attachment and/or fixing of components of the hearing device. Components of the hearing device optionally comprise one or more of receiver, microphone(s), battery, battery door, processor, PCB, etc. and can for example be mounted on the frame.

The hearing device comprises a receiver arranged within the housing. The receiver may be attached to the frame. The housing and the receiver optionally form at least a part of a first mass spring system having a first resonance frequency.

The housing may be deformable, such as elastically deformable. For example, the shell and/or frame of the hearing device may be deformable, e.g., compressible and/or elastic.

In one or more example hearing devices, the housing, such as the shell and/or the frame, comprises a material having a Youngs Modulus of less than 500 MPa. The housing of the hearing device may comprise or be made of a plastic with a Youngs Modulus e.g. of less than 500 MPa. In some examples, the housing of the hearing device comprises an elastomer, such as a thermoplastic elastomer. The housing may comprise an elastomer with a Youngs Modulus of less than 500 MPa. For example, the housing, such as the frame and/or the shell may comprise or be made of Pebax5533. Use of a deformable material for the housing of the hearing device may enable improved shock protection for the receiver of the hearing device.

The housing material may enable an increased compression period when the hearing device impacts a surface, e.g., such as in the first user scenario. The disclosed housing may therefore enable a corresponding reduced acceleration associated with the hearing device impacting a surface, thereby reducing the force, such as shock, that the receiver is subjected to.

The shell may comprise or be made of a material having a Youngs Modulus less than 500 MPa, such as less than 300 MPa. In one or more example hearing devices, the shell comprises or is made of a material, such as an elastomer, having a Youngs Modulus in a range from 120 MPa to 180 Mpa. The shell, such as a first shell part and/or a second shell part, has an outer surface forming at least a part of an outer surface of the hearing device.

The receiver may be attached to the frame of the hearing device. In one or more example hearing devices, a receiver housing of the receiver is hard-mounted to the frame. The receiver for example comprises a receiver housing. The receiver housing of the receiver can for example be seen as the external shell of the receiver. In other words, the receiver may be fixed to the frame via the receiver housing. The frame may comprise or be made of a material having a Youngs Modulus less than 500 Mpa, such as less than 300 Mpa. In one or more example hearing devices, the frame comprises or is made of a material, such as an elastomer, having a Youngs Modulus in a range from 120 MPa to 180 MPa. The frame may have an outer surface forming at least a part of an outer surface of the hearing device.

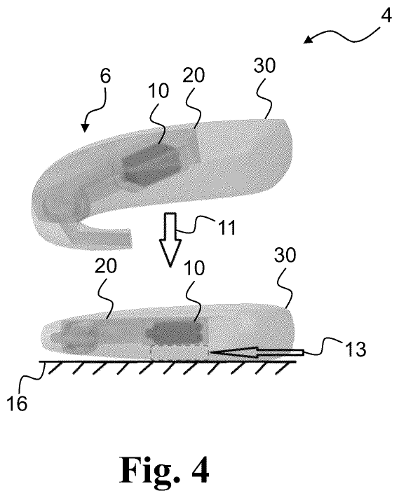

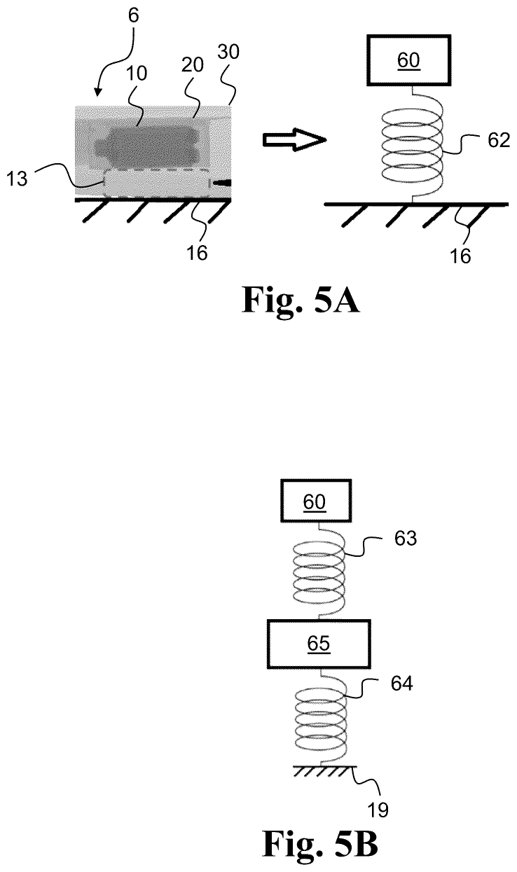

In one or more example hearing devices, the hearing device may be configured to provide shock protection from any angle. In other words, when a force is applied at any point on the outer surface of the hearing device, such as when the hearing device is dropped onto a surface, the hearing device may be configured to provide shock protection for that point, such as the top, bottom, sides, etc. For example, when the hearing device is dropped such that a side of the hearing device, such as indicated in region 13 of FIG. 4 and FIG. 5A, impacts a surface, the housing may deform, e.g., elastically, to reduce the impact force on the components attached to the frame of the hearing device. In some examples, the housing, such as the shell and/or the frame, can be seen as absorbing the impact force via deformation of the housing, such as via deformation of the shell and/or the frame.

The first mass spring system may be modelled for and/or associated with a first user scenario. The first mass spring system can be seen as a model indicating the characteristics and/or properties of the hearing device in the first user scenario, for example when the hearing device, such as the shell, impacts a surface. The first mass spring system for example comprises a mass and a spring. For example, the mass corresponds to the mass of the receiver. The spring for example corresponds with the effective deformable part of the housing, such as one or more of the shell, the frame, and one or more damping elements. For example, the effective deformable part of the housing can be seen as having a spring stiffness, e.g., relating to the Youngs Modulus of the housing material.

The first user scenario can be seen as a scenario where a hearing device impacts a surface, e.g. during an impact period. For example, the first user scenario may be a scenario of a hearing device being dropped, e.g., by a user of the hearing device, onto a surface.

An impact period of the hearing device can be seen as a time period during an impact where the hearing device is in contact with the impact surface, such as from first contact until the hearing device is no longer in contact, such as rebounded away from the impact surface. An example impact period for enabling shock protection of the receiver of the hearing device is for example 0.1 ms, corresponding with a compression time of 0.05 ms

The housing of the hearing device may be configured such that the impact period of the hearing device is longer than 0.1 msl. In other words, the housing of the hearing device may be configured to enable the compression time, such as the deceleration period of the hearing device, to be longer than 0.05 ms. A deceleration period of the hearing device greater than 0.05 ms for example enables shock protection of the hard-mounted receiver.

Fundamental frequency can be seen as the fundamental resonance frequency of the hearing device. Fundamental frequency can for example be calculated using the Equation 1:

$${f}_{n} = \frac{1}{2 ( D P )} \qquad ( 1 )$$

Where fₙ is the fundamental frequency and the deceleration period (DP), also denoted compression time, may be 0.05 ms. For a deceleration period of 0.05 ms, the fundamental frequency can be calculated, using Equation 1, to be 10 kHz. In other words, Equation 1 may be used to calculate fundamental frequency based on a deceleration period, such as a deceleration period of 0.05 ms.

The first resonance frequency can be seen as the fundamental frequency of the first mass spring system. In other words, the first resonance frequency can for example be seen as a first resonant frequency of the first mass spring system. The first resonance frequency is for example the natural frequency where the first mass spring system oscillates at the highest amplitude. In other words, the first resonance frequency can be seen as the resonant frequency of the housing and receiver in the first user scenario.

In one or more example hearing devices, the first resonance frequency is smaller than 10 kHz. A first resonance frequency of less than 10 kHz for example enables shock protection of the receiver. The value of 10 kHz is based on the surface upon which the hearing device impacts being fixed, e.g., non-moving. In other words, the surface upon which the hearing device impacts can be seen as comprising a fixed boundary condition, i.e. the surface is not moving when the hearing device impacts the surface.

In one or more example hearing devices, the first resonance frequency is in the range from 1 kHz to 9.5 kHz.

The first resonance frequency can for example be calculated using Equation 2:

$${f}_{n 1} = \frac{1}{2 π} \sqrt{\frac{s}{m}} \qquad ( 2 )$$

Where fₙ₁ is the first resonance frequency, m is the mass of the receiver, and s is the spring stiffness of the first spring mass system.

As shown in Equation 2, for the first resonance frequency to be lowered, such as less than 10 kHz, m can be increased and/or s can be decreased. The disclosed hearing device can be seen as lowering the spring stiffness, e.g., via a deformable housing, one or more foam pads, and/or a modified housing geometry, such as one or more damping elements.

In some examples, the housing, such as the frame and/or the shell, comprises a material with a Youngs Modulus of less than 500 MPa, e.g., Pebax5533. Use of such a deformable, e.g., compressible, material for the housing enables improved shock protection for the receiver of the hearing device.

In one or more example hearing devices, the housing exhibits a spring stiffness smaller than 790 kN/m. In one or more example hearing devices, the first spring mass system has a spring stiffness of smaller than 790 kN/m. For example, the frame and/or the housing of the hearing device may each exhibit a spring stiffness smaller than 790 kN/m.

The housing and the receiver optionally form at least a part of a second mass spring system having a second resonance frequency, such as a second resonance frequency larger than 10 kHz.

The second mass spring system may be associated with a second user scenario. The second user scenario can be seen as a scenario where a hearing device is worn by a user e.g., behind the ear. The second mass spring system can be seen as a model indicating the characteristics and/or properties of the hearing device in the second user scenario, e.g., while a hearing device, worn by a user, provides audio and/or hearing compensation.

The second mass spring system for example comprises a free boundary condition or a soft suspended boundary condition, e.g., human skin. In other words, the outer surface of BTE touches the skin of human ear, which provides a free/soft boundary condition allowing the hearing device to considered to operate in free and/or soft boundary conditions. This is contrary to the first user scenario, where the surface of device is touching the hard ground floor in a drop test, and the ground provides a hard/fixed boundary to the device.

The second resonance frequency can be seen as the fundamental frequency of the second mass spring system. The second resonance frequency can for example be seen as a second resonant frequency of the second mass spring system. The second resonance frequency is for example the natural frequency where the second mass spring system oscillates at the highest amplitude. In other words, the second resonance frequency can be seen as the resonant frequency of the housing and receiver in the second user scenario.

A second resonance frequency such as larger than 10 kHz for example enables the receiver of the hearing device, e.g., a hard mounted receiver, to have minimal undesirable resonance which may otherwise reduce the quality of an output audio signal provided by the receiver. The receiver may for example be hard mounted to the frame using a press fit technique. In some examples, the receiver may be hard mounted to the frame using glue. In some examples, the receiver may be hard mounted to the frame via a click mechanism.

In equation 3 below, fₙ₂ is the second resonance frequency, m is the mass of the receiver, M is the mass of the remaining part of the hearing device, such as the frame, the shell, batteries, microphone, etc., and s1 is the spring stiffness between receiver and the housing. Human ear skin stiffness, as indicated by spring 64 of FIG. 5B, may be near zero and can be seen as negligible, such as near zero. Therefore the human ear skin stiffness is not included in equation 3. The second resonance frequency of the second mass spring system may therefore be calculated using Equation 3:

$${f}_{n 2} = \frac{1}{2 π} \sqrt{\frac{( m + M ) {s}_{1}}{m M}} \qquad ( 3 )$$

As the boundary condition for the second mass spring system is different to that of the first mass spring system, the housing of the disclosed hearing device for example enables the second resonance frequency to be greater than 10 KHz while the first resonance frequency may be less than 10 KHz.

The disclosed hearing device may for example be configured such that the first resonance frequency, e.g. as determined using Equation 1, is less than 10 KHz and/or the second resonance frequency, e.g. as calculated using Equation 2, is larger than 10 KHz. When the hearing device has a first resonance frequency of less than 10 kHz, and/or a second resonance frequency larger than 10 kHz, the hearing device may advantageously enable shock protection of the receiver while minimizing the generation of undesired audio artifacts, e.g., caused by feedback related to resonance.

In one or more example hearing devices, the shell is a multi-part shell comprising a first shell part and a second shell part separately mounted on the frame. For example, the first shell part and/or the second shell part may be mounted on or attached to the frame.

In one or more example hearing devices, the frame forms a part of an outer surface of the hearing device. For example, a part of the frame may be externally visible. In other words, a part of the frame may not be covered by the shell.

In one or more example hearing devices, the hearing device comprises a printed circuit board mounted on the frame. The printed circuit board may have one or more components, such as processor(s), transceiver, microphone(s), mounted thereon, the components optionally configured to carry out one or more operations of the hearing device.

In one or more example hearing devices, the housing is made of a silicon-free material. The silicon-free material disclosed herein is to be understood as a material comprising less than 1% Silicon.

In one or more example hearing devices, the frame is made from a material having a Youngs Modulus larger than 1 GPa and comprises one or more damping elements. In one or more example hearing devices, the one or more damping elements contact the shell. In one or more example hearing devices, the shell is made from a material having a Youngs Modulus larger than 1 GPa and comprises one or more damping elements. In one or more example hearing devices, the one or more damping elements contact the frame. The one or more damping elements can be seen as elements configured to reduce, delay and/or alter the peak impact force of the hearing device when impacting a surface, e.g., in the first user scenario, thus reducing, delaying and/or altering the transfer of impact force from the shell to the frame of the hearing device. In other words, the one or more damping elements may be configured to deform to increase the time period of the acceleration associated with the impact. The one or more damping elements may for example be configured to deform plastically and/or elastically. The one or more damping elements can for example be seen as reducing the stiffness of the housing. The one or more damping elements are for example located between the frame and the shell of the housing. The one or more damping elements may for example be a part of the frame and/or the shell.

In some examples, the one or more damping elements comprise curved elements (in other words bending edges). The curved elements may for example comprise a material with a similar and/or same stiffness to that of the shell and/or frame of the hearing device. In some examples, the curved elements may be configured such that when the hearing device impacts a surface, the curved elements deform at an angle to the direction of the impact force. In other words, when an impact force is applied to the shell of the hearing device, e.g., when the hearing device is dropped on a surface, the curved element may deform, e.g., plastically and/or elastically, such that its curvature increases. This may advantageously prolong the impact period, thereby reducing the overall force subjected to the receiver by an impact. This may advantageously reduce the damage incurred to the receiver by the impact.

The one or more damping elements may for example enable the first resonance frequency to be below 10 kHz and/or the second resonance frequency to be above 10 kHz in a hearing device where the frame and/or housing is made from a material having a Youngs Modulus larger than 1 GPa.

In one or more example hearing devices, the housing comprises one or more foam pads arranged between the frame and the shell.

The one or more foam pads can for example be seen as damping elements. The one or more foam pads can for example be seen as foam blocks. In some examples, a foam pad is made of a foam material. For example, foam pad(s) is/are made of a polyurethane open cell foam, such as Poron foam 79-09021P. Foam pad(s) may have a cell pore size in the range from xx to yy.

The one or more foam pads may for example enable the first resonance frequency to be below 10 kHz and/or the second resonance frequency to be above 10 kHz in a hearing device where the frame and/or housing is made from a material having a Youngs Modulus larger than 1 GPa.

In some examples, the one or more foam pads comprise a material with a Young's Modulus less than that of the shell of the hearing device. For example, foam pad(s) of the one or more foam pads may have a Young's Modulus of less than 500 MPa.

In some examples, foam pad(s) of the one or more foam pads may be located between the receiver and the frame. For example, a foam pad of the one or more foam pads may be in contact with the frame and the receiver.

When the housing, e.g., the frame and/or the shell, is made of a deformable material, e.g., with a Youngs Modulus of less than 500 MPa, e.g., Pebax5533, the deformation of the housing upon impact may enable shock protection of the receiver without requiring additional deforming, such as energy absorbing, elements, e.g., foam pads and/or damping elements. In some examples, foam pads and/or the damping elements may require additional space in the hearing device, e.g., between the frame and the shell. When the housing is made of a deformable material, this may enable the hearing device to remain the same size while also providing shock protection to the receiver.

In some examples, the hearing device may comprise one or more foam pads and/or one or more damping elements, without the size of the hearing device requiring to be increased.

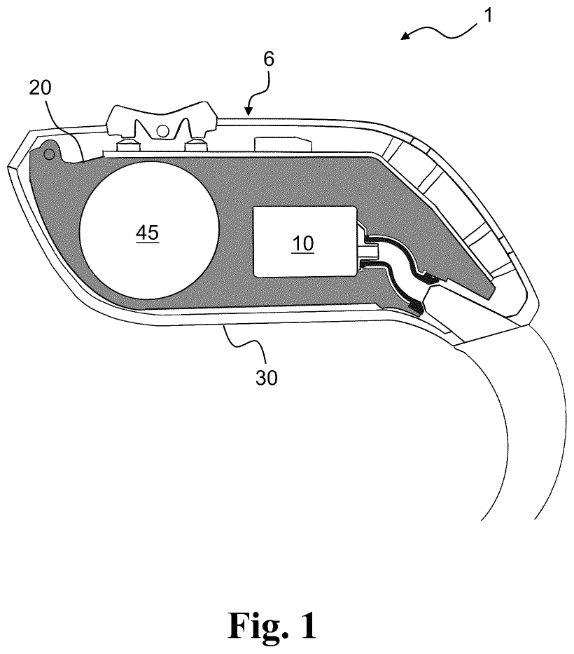

FIG. 1 shows an exemplary hearing device 1 according to the disclosure. The hearing device 1 comprises a housing 6 comprising a frame 20 and a shell 30. The hearing device 1 comprises a receiver 10 arranged within the housing 6. The housing 6 and the receiver 10 form at least a part of a first mass spring system having a first resonance frequency. The receiver 10 and the frame 20 and/or shell 30 form at least part of a first mass spring system. The housing 6 and the receiver 10 of hearing device 1 form at least a part of a second mass spring system having a second resonance frequency larger than 10 kHz. The hearing device 1 further comprises a battery 45.

The receiver 10 for example comprises a receiver housing. The receiver housing of the receiver 10 can for example be seen as the external shell of the receiver. The receiver housing of receiver 10 is for example hard mounted to the frame 20. In other words, the receiver 10 may be fixed, e.g. by glue or press-fit, to the frame 20 directly via the receiver housing.

The receiver 10 may for example be hard mounted to the frame 20 using a press fit technique. In some examples, the receiver 10 may be hard mounted to the frame 20 using glue. In some examples, the receiver 10 may be hard mounted to the frame 20 via a clicking mechanism.

The housing 6, e.g., the frame 20 and/or the shell 30, of the hearing device 1 may comprise an elastomer, such as a thermoplastic elastomer. The housing 6, e.g., the frame 20 and/or the shell 30, of the hearing device 1 for example comprises an elastomer with a Youngs Modulus of less 500 MPa.

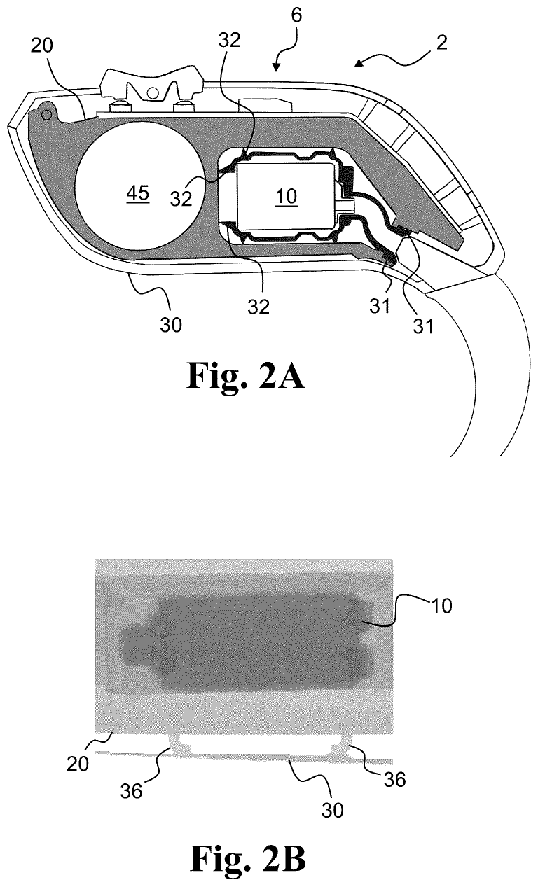

FIGS. 2A-B show one or more damping elements of an exemplary hearing device according to the disclosure.

FIG. 2A shows a hearing device 2. The hearing device 2 comprises a housing 6 comprising a frame 20 and a shell 30. The hearing device 2 comprises a receiver 10 arranged within the housing 6. The housing 6 and the receiver 10 hearing device 2 form at least a part of a first mass spring system having a first resonance frequency. The receiver 10 and the frame 20 and/or shell 30 form at least part of a first mass spring system. The housing 6 and the receiver 10 of hearing device 2 form at least a part of a second mass spring system having a second resonance frequency larger than 10 kHz. The hearing device 2 further comprises a battery 45.

The hearing device 2, e.g., the housing 6, comprises one or more damping elements 32. The one or more damping elements 32 are attached to the frame 20 at attachment points 31. The one or more damping elements 32 contact the frame 20 and/or the shell 30. The shell 30 can be seen as comprising an inner, such as internal to the hearing device 2, surface and an outer, such as external to the hearing device 2, surface. The one or more damping elements 32 can be seen as contacting the inner surface of the shell 30. The frame 20 and/or the shell 30 can for example be made from a material having a Youngs Modulus larger 1 GPa.

The one or more damping elements 32 are for example configured to deform when a force is applied. The one or more damping elements 32 may be in contact with the receiver. The one or more damping elements 32 can be seen as curved elements and/or bending edges. The one or more damping elements 32 are for example made from a material with a Youngs Modulus greater than 1 Gpa.

FIG. 2B shows an example section of the disclosed hearing device. FIG. 2B shows a receiver 10, a frame 20, a shell 30, and one or more damping elements 36.

The frame 20 of hearing device 2 for example comprises the one or more damping elements 36. For example, the one or more damping elements 36 may be attached to the frame 20. The one or more damping elements 36 are for example configured to deform when a force is applied, e.g., when the hearing device 2 impacts a surface, e.g., in the first user scenario.

The shell 30 of hearing device 2 for example comprises the one or more damping elements 36. For example, the one or more damping elements 36 may be attached to the shell 30.

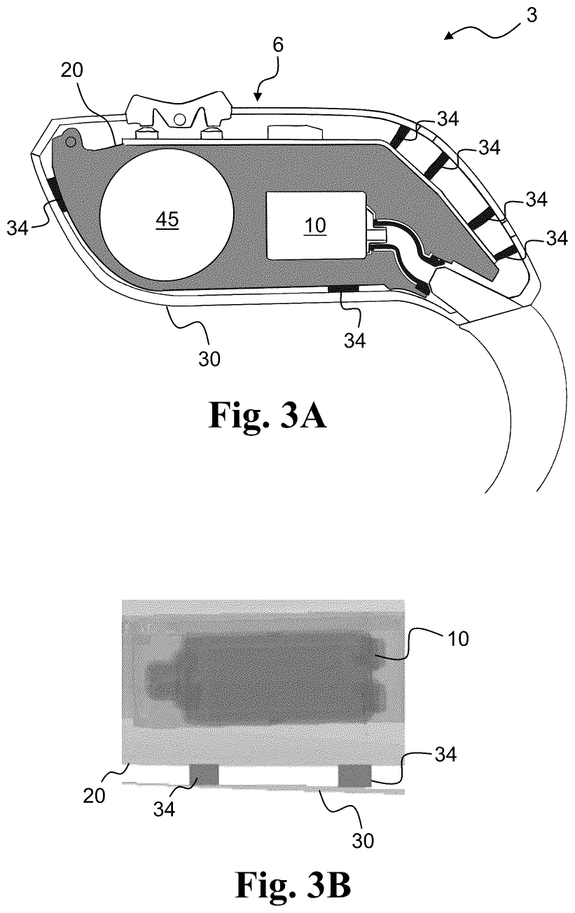

FIGS. 3A-B show one or more foam pads of an exemplary hearing device according to the disclosure.

FIG. 3A shows a hearing device 3. The hearing device 3 comprises a housing 6 comprising a frame 20 and a shell 30. The hearing device 3 comprises a receiver 10 arranged within the housing 6. The housing 6 and the receiver 10 of hearing device 3 form at least a part of a first mass spring system having a first resonance frequency. The receiver 10 and the frame and/or shell form at least part of a first mass spring system. The housing 6 and the receiver 10 of hearing device 3 form at least a part of a second mass spring system having a second resonance frequency larger than 10 kHz. The hearing device 3 further comprises a battery 45.

The hearing device 3, e.g., the housing 6, comprises one or more foam pads 34 arranged between the frame and the shell. The one or more foam pads 34 may for example be attached to the frame 20 and/or the shell 30. The one or more foam pads 34 for example contact the frame 20 and/or the shell 30. The shell 30 can be seen as comprising an inner surface and an outer surface. The one or more foam pads 34 can be seen as contacting the inner surface of the shell 30. The frame 20 and/or the shell 30 can for example be made from a material having a Youngs Modulus larger 1 GPa.

The one or more foam pads 34 are for example configured to deform when a force is applied, e.g., when the hearing device 2 impacts a surface, e.g., in the first user scenario. The one or more foam pads 34 are for example made from a material with a Youngs Modulus less than 1 GPa.

FIG. 3B shows an example section of the disclosed hearing device. FIG. 2B shows a receiver 10, a frame 20, a shell 30, and one or more foam pads 34.

The frame 20 of hearing device 2 for example comprises the one or more foam pads 34. For example, the one or more foam pads 34 may be attached to the frame 20. The one or more foam pads 34 are for example configured to deform when a force is applied. The shell 30 is for example made of a material having a Youngs Modulus of larger than 1 GPa.

The shell 30 of hearing device 3 for example comprises the one or more foam pads 34. For example, the one or more foam pads 34 may be attached to the shell 30. FIG. 4 shows an exemplary hearing device 4 in a first user scenario according to the disclosure. The hearing device 4 comprises a receiver 10, frame 20 and/or a shell 30. FIG. 4 shows the hearing device 4 being dropped onto a surface 16.

The arrow 11 indicates the direction that the hearing device 4 is dropped in. The two hearing devices shown in FIG. 4 are the same hearing device 4 at different moments in time during a fall towards a surface 16.

In some examples, when the hearing device 4 is dropped onto a surface 16, e.g., the ground, from an operational height, e.g., 1 m, the impact period required for sufficient shock protection of the receiver 10 may be greater than or equal to 0.1 ms to provide shock protection to the receiver. In some examples, an impact period of greater or equal to 0.1 ms may prevent damage to the receiver.

For example, when the hearing device 4 is dropped, all components of the hearing device, e.g., the receiver 10, frame 20 and shell 30, are falling towards the surface 16 at the same velocity. When the hearing device 4 impacts surface 16, the housing 30, the one or more damping elements and/or the one or more foam pads may absorb the impact energy, such as by deforming. In other words, the housing 30, one or more damping elements and/or one or more foam pads may enable a slower change in acceleration of the receiver 10, thereby enabling a lower force, such as peak force, to be applied to the receiver during an impact.

The region 13 of the hearing device 4 can for example be seen as the region of the hearing device 4 that is configured to deform and/or compress. In other words, the region 13 can be seen as the effective deformable region of the hearing device, e.g., the shell 30. The region 13 for example comprises the shell 30, the one or more damping elements and/or the one or more foam pads. During impact, the region 13 may deform and/or compress thereby slowing the velocity of the receiver. In other words, the reaction force of the compression may slow the receiver. The deformation and/or compression of region 13 for example provides shock protection to the receiver.

FIG. 5A shows an exemplary first mass spring system and a section of a corresponding hearing device according to the disclosure. FIG. 5A shows a receiver 10, a frame 20 and a shell 30. FIG. 5A further shows a region 13 and a surface 16. FIG. 5A shows a first mass and spring system comprising a mass 60 and a spring 62. The mass 60 for example corresponds with the receiver 10 and the spring 62 for example corresponds with the region 13.

FIG. 5B shows an exemplary second mass spring system according to the disclosure. FIG. 5B shows a mass 60 and a mass 65. FIG. 5B shows a spring 63 and a spring 64.

Mass 60 corresponds with the receiver, e.g., receiver 10 as shown in FIGS. 1-5A. Mass 65 corresponds with the remaining part of the housing, e.g., the frame and/or the shell. Spring 63 corresponds with the area between the receiver and the housing, e.g., frame and/or shell, of the hearing aid. Spring 64 corresponds with the human ear skin stiffness. The spring 64 for example has a negligible stiffness, such as a stiffness of near zero. FIG. 5B shows a surface of human skin 19, such as human ear skin.

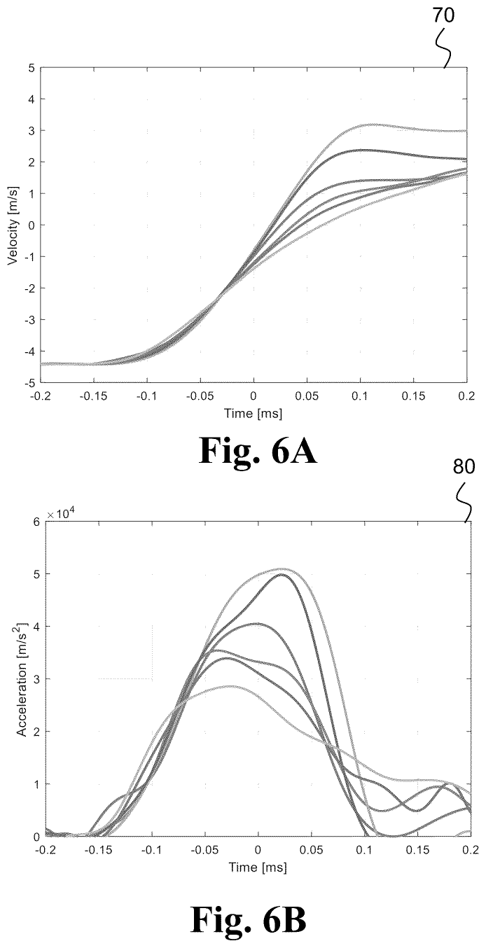

FIGS. 6A-B show graphs indicating the measured velocities and related acceleration from drop tests on 6 hearing devices.

FIG. 6A shows a graph 70 of the measured impact velocity of hearing devices during an impact with a surface. FIG. 6B shows a graph 80 of the calculated acceleration from the measured impact velocity of hearing devices during an impact with a surface. The drop test was done on a pendulum device, where the pendulum was released from 1 m height, and the velocity on the receiver is measured by a laser doppler vibrometer by pointing the laser beam to the receiver surface through a hole in the BTE devices.

At the beginning of the impact period (approximately −0.15 ms), the hearing device, such as hearing devices 1-4 of FIGS. 1-4, impacts the impact surface at a velocity of −4.4 m/s, where a negative velocity indicates a velocity towards the impact surface, such as a downwards velocity. Meanwhile, the receiver, such as receiver 10 of FIGS. 1-5A, in the hearing device has the same speed towards the impact surface. The components of the hearing device, e.g., shell, frame, printed circuit board, and other parts, between the receiver and the impact surface are deformed, e.g., compressed, and the reaction force from the deformation, e.g., compression, slows down the speed of the receiver.

When the receiver's speed becomes zero, the receiver starts to move away from ground. This occurs at the point where the gradient of the lines of graph 80 is equal to 0. The receiver is usually exposed to the highest acceleration around this moment. Meanwhile, the components of the hearing device start returning to their original shape, e.g., decompressing.

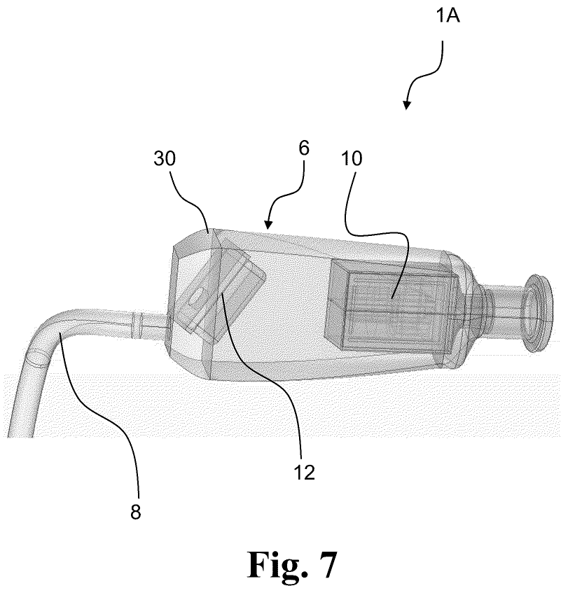

FIG. 7 shows an exemplary hearing device 1A according to the disclosure. The hearing device 1A comprises a housing 6 being an in-the-ear (ITE) housing configured to be at least partly arranged in an ear canal. The housing 6 is optionally connected to a BTE part (not shown) of the hearing device via tube or wire 8. The housing 6 comprises a frame (not shown) and a shell 30, the hearing device 1A comprising a receiver 10 and optionally a microphone 12 arranged within the housing 6. The housing 6 and the receiver 10 form at least a part of a first mass spring system having a first resonance frequency. The receiver 10 and the frame and/or shell 30 form at least part of a first mass spring system. The housing 6 and the receiver 10 of hearing device 1A form at least a part of a second mass spring system having a second resonance frequency larger than 10 kHz.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It may be appreciated that the figures comprise some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, and systems described herein are described in the general context of method steps processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

### LIST OF REFERENCES

1-4 hearing device
1A hearing device
6 housing
8 tube or wire
10 receiver
11 direction
12 microphone
13 region
16 surface
19 surface of human skin
20 frame
30 shell
31 attachment points
32 one or more damping elements
34 one or more foam pads
36 one or more damping elements
45 battery
60 mass
62 spring
63 spring
64 spring
65 mass
70 graph
80 graph

1. A hearing device comprising:
a housing comprising a frame and a shell; and
a receiver in the housing;
wherein the housing and the receiver form at least a part of a first mass spring system having a first resonance frequency; and
wherein the housing and the receiver form at least a part of a second mass spring system having a second resonance frequency larger than 10 kHz.

2. The hearing device according to claim 1, wherein the housing comprises a material having a Youngs Modulus of less than 500 MPa.

3. The hearing device according to claim 1, wherein the shell comprises a material having a Youngs Modulus in a range from 120 MPa to 180 MPa.

4. The hearing device according to claim 1, wherein the frame comprises a material having a Youngs Modulus in a range from 120 MPa to 180 MPa.

5. The hearing device according to claim 1, wherein the first resonance frequency is smaller than 10 kHz.

6. The hearing device according to claim 5, wherein the first resonance frequency is in a range from 1 kHz to 9.5 kHz.

7. The hearing device according to claim 1, wherein the housing exhibits a spring stiffness smaller than 790 kN/m.

8. The hearing device according to claim 1, wherein the receiver comprises a receiver housing, and wherein the receiver housing of the receiver is hard-mounted to the frame.

9. The hearing device according to claim 1, wherein the shell is a multi-part shell comprising a first shell part and a second shell part separately mounted on the frame.

10. The hearing device according to claim 1, wherein the frame forms a part of an outer surface of the hearing device.

11. The hearing device according to claim 1, wherein the hearing device comprises a printed circuit board mounted to the frame.

12. The hearing device according to claim 1, wherein the housing is made of a silicon-free material.

13. The hearing device according to claim 1, wherein the frame is made from a material having a Youngs Modulus larger than 1 GPa and comprises one or more damping elements, wherein the one or more damping elements contact the shell.

14. The hearing device according to claim 1, wherein the shell is made from a material having a Youngs Modulus larger than 1 GPa and comprises one or more damping elements, wherein the one or more damping elements contact the frame.

15. The hearing device according to claim 1, wherein the housing comprises one or more foam pads between the frame and the shell.
